(19) United States
(12) Patent Application Publication
(10) Pub. No.: US 2024/0088495 A1
(43) Pub. Date: Mar. 14, 2024

(54) ALKALINE BATTERY

(71) Applicant: MURATA MANUFACTURING CO., LTD., Kyoto (JP)

(72) Inventors: Keisuke MAEGAWA, Kyoto (JP); Satoshi SATO, Kyoto (JP)

(21) Appl. No.: 18/517,785

(22) Filed: Nov. 22, 2023

Related U.S. Application Data
(63) Continuation of application No. PCT/JP2022/023226, filed on Jun. 9, 2022.

(30) Foreign Application Priority Data
Jul. 19, 2021 (JP) 2021-119114

(51) Int. Cl. H01M 50/186; H01M 6/04; H01M 50/109; H01M 50/153; H01M 50/167; H01M 50/586; H01M 50/593

(52) U.S. Cl. CPC H01M 50/186; H01M 6/04; H01M 50/109; H01M 50/153; H01M 50/167; H01M 50/586; H01M 50/593

(57) ABSTRACT

An alkaline battery includes a positive electrode containing member, a negative electrode containing member, a positive electrode, a negative electrode, a frame-shaped member, a separator, and a sealing member. The positive electrode is contained inside the positive electrode containing member. The negative electrode and the frame-shaped member are contained inside the negative electrode containing member. The separator is disposed between the positive electrode and the negative electrode. The sealing member is disposed between the positive electrode containing member and the negative electrode containing member, and is separated from the frame-shaped member. The positive electrode containing member and the negative electrode containing member are crimped to each other with the sealing member interposed between the positive electrode containing member and the negative electrode containing member. The negative electrode includes a negative electrode active material and an alkaline electrolytic solution. The frame-shaped member surrounds the negative electrode and adjoins the separator.

### CROSS REFERENCE TO RELATED APPLICATIONS

The present application is a continuation of PCT patent application no. PCT/JP2022/023226, filed on Jun. 9, 2022, which claims priority to Japanese patent application no. 2021-119114, filed on Jul. 19, 2021, the entire contents of which are incorporated herein by reference.

### BACKGROUND

The present technology relates to an alkaline battery.

An alkaline battery has been widely used in a device such as a portable game machine, a clock, or an electronic calculator. A configuration of the alkaline battery has been considered in various ways.

Specifically, in a flat rectangular battery in which an outer case and an inner case are crimped to each other with an insulating gasket interposed therebetween, an inner peripheral surface of the inner case is provided with a metal reinforcing member. Further, in a flat battery in which an exterior can and a seal can are crimped to each other with a gasket interposed therebetween, the gasket is extended to an inner wall surface of the seal can.

### SUMMARY

The present technology relates to an alkaline battery.

Consideration has been given in various ways regarding a configuration of an alkaline battery; however, a liquid leakage resistance characteristic of the alkaline battery still remains insufficient. Accordingly, there is still room for improvement in terms thereof.

It is desirable to provide an alkaline battery that makes it possible to achieve a superior liquid leakage resistance characteristic.

An alkaline battery according to an embodiment of the present technology includes a positive electrode containing member, a negative electrode containing member, a positive electrode, a negative electrode, a frame-shaped member, a separator, and a sealing member. The positive electrode is contained inside the positive electrode containing member. The negative electrode and the frame-shaped member are contained inside the negative electrode containing member. The separator is disposed between the positive electrode and the negative electrode. The sealing member is disposed between the positive electrode containing member and the negative electrode containing member, and is separated from the frame-shaped member. The positive electrode containing member and the negative electrode containing member are crimped to each other with the sealing member interposed between the positive electrode containing member and the negative electrode containing member. The negative electrode includes a negative electrode active material and an alkaline electrolytic solution. The frame-shaped member surrounds the negative electrode and adjoins the separator.

According to the alkaline battery of an embodiment of the present technology, the positive electrode containing member in which the positive electrode is contained and the negative electrode containing member in which the negative electrode and the frame-shaped member are contained are crimped to each other with the sealing member interposed therebetween. The sealing member is separated from the frame-shaped member. The separator is disposed between the positive electrode and the negative electrode. The negative electrode includes the negative electrode active material and the alkaline electrolytic solution. The frame-shaped member surrounds the negative electrode and adjoins the separator. This configuration makes it possible to achieve a superior liquid leakage resistance characteristic.

Note that effects of the present technology are not necessarily limited to those described herein and may include any of a series of suitable effects in relation to the present technology.

### BRIEF DESCRIPTION OF THE FIGURES

FIG. 1 is a sectional view of a configuration of an alkaline battery according to an embodiment of the present technology.

FIG. 2 is a plan view of a configuration of a main part of the alkaline battery illustrated in FIG. 1.

FIG. 3 is a sectional view of a configuration of an alkaline battery of a comparative example.

FIG. 4 is a sectional view of a configuration of an alkaline battery according to an embodiment.

FIG. 5 is a sectional view of a configuration of an alkaline battery according to an embodiment.

FIG. 6 is a sectional view of a configuration of an alkaline battery according to an embodiment.

### DETAILED DESCRIPTION

One or more embodiments of the present technology are described below in further detail including with reference to the drawings.

A description is given first of an alkaline battery according to an embodiment of the present technology.

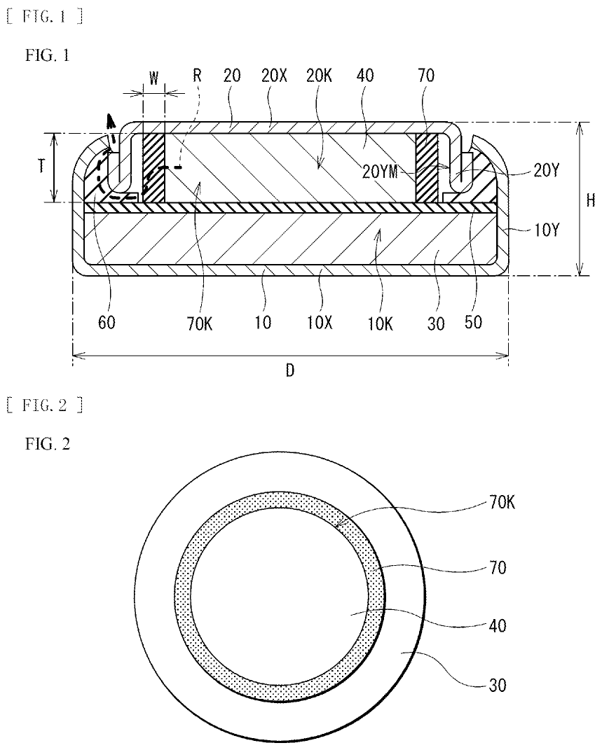

FIG. 1 illustrates a sectional configuration of the alkaline battery. FIG. 2 illustrates a plan configuration of a main part of the alkaline battery illustrated in FIG. 1. Note that FIG. 2 illustrates only a positive electrode 30, a negative electrode 40, and a negative electrode ring 70 among a series of components of the alkaline battery illustrated in FIG. 1, with the negative electrode ring 70 shaded.

The alkaline battery to be described here is what is called a primary battery. The alkaline battery causes a discharge reaction to proceed using an alkaline electrolytic solution to be described later.

Specifically, as illustrated in FIGS. 1 and 2, the alkaline battery includes a positive electrode container 10, a negative electrode container 20, the positive electrode 30, the negative electrode 40, a separator 50, a gasket 60, and the negative electrode ring 70.

This alkaline battery has a flat and columnar three-dimensional shape, and is commonly referred to by a term such as a coin type or a button type. The alkaline battery has an outer diameter D and a height H. The outer diameter D is specifically in a range from 4.0 mm to 12.0 mm both inclusive, although not particularly limited thereto. The height H is specifically in a range from 0.8 mm to 5.4 mm both inclusive, although not particularly limited thereto. Here, the three-dimensional shape of the alkaline battery is flat and circular columnar.

As illustrated in FIG. 1, the positive electrode container 10 is a positive electrode containing member that contains the positive electrode 30 and other components. The positive electrode container 10 has a bowl-shaped structure with one end part open and another end part closed.

Specifically, the positive electrode container 10 has a bowl shape and includes a bottom part 10X and a sidewall part 10Y that are coupled to each other. The bottom part 10X serves as a first bottom part. The sidewall part 10Y serves as a first sidewall part. The positive electrode container 10 has an opening 10K that is open on a side facing toward the negative electrode container 20. The opening 10K serves as a first opening.

Here, the positive electrode container 10 is electrically conductive and adjoins the positive electrode 30. The positive electrode container 10 thus also serves as a current collector of the positive electrode 30 and as an external coupling terminal of the positive electrode 30. The external coupling terminal of the positive electrode 30 is what is called a positive electrode terminal.

The positive electrode container 10 includes any one or more of metal materials including, without limitation, iron, nickel, and stainless steel (SUS). Thus, the positive electrode container 10 is a bowl-shaped metal can having the opening 10K. The stainless steel is not particularly limited in kind, and specific examples thereof include SUS430.

Note that the positive electrode container 10 may have a single-layer structure or a multilayer structure. The positive electrode container 10 may have a surface plated with a metal material. Specific examples of the metal material include nickel.

As illustrated in FIG. 1, the negative electrode container 20 is a negative electrode containing member that contains the negative electrode 40, the negative electrode ring 70, and other components. The negative electrode container 20 has a bowl-shaped structure with one end part open and another end part closed, as with the positive electrode container 10.

Specifically, the negative electrode container 20 has a bowl shape and includes a bottom part 20X and a sidewall part 20Y that are coupled to each other. The bottom part 20X serves as a second bottom part. The sidewall part 20Y serves as a second sidewall part. The negative electrode container 20 has an opening 20K that is open on a side facing toward the positive electrode container 10. The opening 20K serves as a second opening.

Here, the negative electrode container 20 is electrically conductive and adjoins the negative electrode 40. The negative electrode container 20 thus also serves as a current collector of the negative electrode 40 and as an external coupling terminal of the negative electrode 40. The external coupling terminal of the negative electrode 40 is what is called a negative electrode terminal.

The negative electrode container 20 includes any one or more of metal materials including, without limitation, nickel, copper, and stainless steel. Thus, the negative electrode container 20 is a bowl-shaped metal can having the opening 20K. Details of the stainless steel are as described above.

Note that the negative electrode container 20 may have a single-layer structure or a multilayer structure. Specifically, the negative electrode container 20 may include a three-layer cladding material in which a nickel layer, a stainless steel layer, and a copper layer are stacked in this order. In this case, the copper layer is disposed on an inner side, and the nickel layer is disposed on an outer side. The copper layer thus serves as the current collector of the negative electrode 40.

Here, the opening 20K has an inner diameter smaller than an inner diameter of the opening 10K. The positive electrode container 10 and the negative electrode container 20 are thus disposed to allow the openings 10K and 20K to face each other, and the negative electrode container 20 is partly placed inside the positive electrode container 10. Further, the sidewall parts 10Y and 20Y are crimped to each other with the gasket 60 interposed therebetween, and as a result, the positive electrode container 10 and the negative electrode container 20 are crimped to each other with the gasket 60 interposed therebetween. Thus, the positive electrode container 10 and the negative electrode container 20 are sealed and fixed to each other by means of the gasket 60. In this manner, the positive electrode container 10 and the negative electrode container 20 are sealed in a state where the positive electrode 30, the negative electrode 40, the separator 50, the negative electrode ring 70, and other components are contained inside.

In this case, as illustrated in FIG. 1, the sidewall part 20Y may extend toward the positive electrode container 10 and then be folded outward to extend away from the positive electrode container 10. A reason for this is that this improves a sealing characteristic of the positive electrode container 10 and the negative electrode container 20.

As illustrated in FIGS. 1 and 2, the positive electrode 30 is a coin-shaped pellet. More specifically, the positive electrode 30 is a positive electrode mixture molded into a coin-shaped pellet. Here, the positive electrode 30 has an outer diameter greater than an outer diameter of the negative electrode 40. The positive electrode 30 is contained inside the positive electrode container 10 and includes a positive electrode active material.

Although not particularly limited in kind, the positive electrode active material specifically includes any one or more of materials including, without limitation, silver oxide and manganese dioxide.

Note that the positive electrode 30 may further include any one or more of materials including, without limitation, a positive electrode binder and a positive electrode conductor. The positive electrode binder includes any one or more of polymer compounds. Specific examples of the polymer compounds include a fluorine-based polymer compound such as polytetrafluoroethylene. The positive electrode conductor includes any one or more of electrically conductive materials including, without limitation, a carbon material. Specific examples of the carbon material include carbon black, and graphite.

The positive electrode 30 may further include a silver-nickel composite oxide (nickelite). A reason for this is that upon generation of a hydrogen gas caused by a reaction between a later-described zinc-based material included in the negative electrode 40 and the alkaline electrolytic solution, the silver-nickel composite oxide absorbs the generated hydrogen gas to thereby suppress an increase in pressure inside the positive electrode container 10 and the negative electrode container 20.

As illustrated in FIGS. 1 and 2, the negative electrode 40 is contained inside the negative electrode container 20 and includes a negative electrode active material and the alkaline electrolytic solution. The negative electrode 40 is thus what is called a negative electrode mixture in gel form.

Although not particularly limited in kind, the negative electrode active material specifically includes one or more of zinc-based materials. The term “zinc-based material” is a generic term for a material that includes zinc as a constituent element. Specific examples of the zinc-based material include a zinc alloy.

The alkaline electrolytic solution includes any one or more of aqueous solutions including respective alkali metal hydroxides, and is a solution in which one or more alkali metal hydroxides are dispersed or dissolved in an aqueous solvent. The aqueous solvent is not particularly limited in kind, and specific examples thereof include pure water and distilled water. The alkali metal hydroxides are not particularly limited in kind, and specific examples thereof include sodium hydroxide and potassium hydroxide.

The alkaline electrolytic solution is included in the negative electrode 40. In addition, the positive electrode 30, the separator 50, or both may be impregnated with the alkaline electrolytic solution, or the alkaline electrolytic solution may be present in any gap inside the positive electrode container 10 or inside the negative electrode container 20.

Note that the negative electrode 40 may further include a thickener. The thickener is what is called a gelling agent, and includes any one or more of polymer compounds. Although not particularly limited in kind, the polymer compounds specifically include a cellulose-based water-soluble polymer compound and a water-absorbent polymer compound. Specific examples of the polymer compounds include carboxymethyl cellulose and sodium polyacrylate.

As illustrated in FIG. 1, the separator 50 is disposed between the positive electrode 30 and the negative electrode 40. The positive electrode 30 and the negative electrode 40 are thus opposed to each other with the separator 50 interposed therebetween. The separator 50 may be impregnated with the alkaline electrolytic solution, as described above.

The separator 50 may have a single-layer structure or a multilayer structure. Specifically, the separator 50 may have a multilayer structure (a three-layer structure) in which a nonwoven fabric, cellophane, and a microporous film are stacked in this order. The microporous film includes, for example, a graft copolymer in which a methacrylic acid is graft-polymerized with polyethylene.

As illustrated in FIG. 1, the gasket 60 is disposed between the positive electrode container 10 and the negative electrode container 20. The gasket 60 is sealing member that seals a gap between the positive electrode container 10 and the negative electrode container 20. The gasket 60 has a ring-shaped structure, and thus entirely seals the gap between the positive electrode container 10 and the negative electrode container 20. As a result, the positive electrode container 10 and the negative electrode container 20 are insulated from each other via the gasket 60.

The gasket 60 includes an insulating material such as a polymer compound having an insulating property. Specific examples of the polymer compound include polyethylene, polypropylene, and nylon.

Here, as illustrated in FIG. 1, the gasket 60 is introduced from the gap between the positive electrode container 10 and the negative electrode container 20 to the inside of the positive electrode container 10 and the negative electrode container 20 along a surface of the separator 50. The gasket 60 is separated from the negative electrode ring 70 and terminates without being extended along an inner wall surface 20YM of the sidewall part 20Y.

As illustrated in FIGS. 1 and 2, the negative electrode ring 70 is a frame-shaped member that defines a range of provision of the negative electrode 40. The negative electrode ring 70 is contained inside the negative electrode container 20 together with the negative electrode 40. Here, a plan shape defined by an outer edge of the negative electrode ring 70 is substantially circular. The negative electrode ring 70 thus has a substantially circular ring shape.

The negative electrode ring 70 is physically separated from the gasket 60 and is thus a member independent of the gasket 60. Here, the negative electrode ring 70 does not adjoin the gasket 60 and is spaced from the gasket 60.

Further, as described above, the negative electrode ring 70 surrounds the negative electrode 40 to define the range of provision of the negative electrode 40. More specifically, the negative electrode ring 70 has an opening 70K, and the negative electrode 40 is thus disposed inside the opening 70K. As a result, the negative electrode 40 adjoins each of the negative electrode container 20 and the separator 50.

In this case, the negative electrode ring 70 adjoins the separator 50. Note that the negative electrode ring 70 is physically separate from the separator 50 and is thus a member independent of the separator 50.

A reason why the alkaline battery includes the negative electrode ring 70 is that when the negative electrode 40 includes the alkaline electrolytic solution, the negative electrode ring 70 serves as a barrier that suppresses leakage of the alkaline electrolytic solution.

The leakage of the alkaline electrolytic solution described here means that, as will be described later, the alkaline electrolytic solution included in the negative electrode 40 moves along a liquid leakage path R, and more specifically, that the alkaline electrolytic solution is released to the outside of the positive electrode container 10 and the negative electrode container 20 through the gasket 60.

By using the negative electrode ring 70 serving as the barrier, the liquid leakage path R increases in path length, and accordingly the leakage of the alkaline electrolytic solution is suppressed even if the negative electrode 40 includes the alkaline electrolytic solution. A reason why the leakage of the alkaline electrolytic solution is suppressed will be described in detail later.

Note that as long as the negative electrode ring 70 adjoins the separator 50, the negative electrode ring 70 may or may not adjoin the negative electrode container 20. In other words, the negative electrode ring 70 may be separated from the negative electrode container 20 and therefore the negative electrode ring 70 and the negative electrode container 20 may have a gap therebetween.

In particular, the negative electrode ring 70 preferably adjoins the negative electrode container 20, as illustrated in FIG. 1. A reason for this is that by allowing the negative electrode ring 70 to adjoin both the separator 50 and the negative electrode container 20, the liquid leakage path R further increases in path length to allow for further suppression of the leakage of the alkaline electrolytic solution.

Further, the negative electrode ring 70 may have an electrical conducting property or an insulating property. A reason for this is that as described above, the leakage of the alkaline electrolytic solution is suppressed regardless of a physical property (the electrical conducting property or the insulating property) of the negative electrode ring 70.

The negative electrode ring 70 that has the electrical conducting property includes any one or more of electrically conductive materials including, without limitation, a metal material. Specific examples of the metal material include copper, tin, indium, and zinc. The negative electrode ring 70 that has the insulating property includes any one or more of insulating polymer compounds. Specific examples of the insulating polymer compounds include polyolefin, polyamide, and polycarbonate. The polyolefin is not particularly limited in kind, and specific examples thereof include polyethylene and polypropylene. The polyamide is not particularly limited in kind, and specific examples thereof include nylon 66.

In particular, as illustrated in FIG. 1, the negative electrode ring 70 preferably has the insulating property. A reason for this is that in such a case, an unintentional short circuit is prevented from being caused by the presence of the negative electrode ring 70.

In this case, the negative electrode ring 70 preferably includes any one or more of the insulating polymer compounds. A reason for this is that in such a case, as compared with when the negative electrode ring 70 includes the electrically conductive material, i.e., the metal material, corrosion of the negative electrode ring 70 by the alkaline electrolytic solution is suppressed and accordingly, the leakage of the alkaline electrolytic solution is further suppressed. A further reason is that it becomes possible to easily mold the negative electrode ring 70, which allows for easy formation of the negative electrode ring 70. Note that details of the insulating polymer compounds are as described above.

In particular, the negative electrode ring 70 preferably includes polyolefin, polyamide, or both, as the one or more insulating polymer compounds. A reason for this is that polycarbonate, for example, can hydrolyze in the presence of the alkaline electrolytic solution and can thus cause the negative electrode ring 70 to decompose, whereas polyolefin and polyamide, for example, each do not hydrolyze easily in the presence of the alkaline electrolytic solution, which helps to prevent the negative electrode ring 70 from decomposing easily.

Note that as illustrated in FIG. 1, the negative electrode ring 70 has a thickness T and a width W. The thickness T is a dimension of the negative electrode ring 70 in a direction in which the separator 50 and the bottom part 20X are opposed to each other, that is, in an up-down direction. The width W is a dimension of the negative electrode ring 70 in a direction in which the negative electrode 40 and the sidewall part 20Y are opposed to each other, that is, in a left-right direction.

In this case, a ratio W/T of the width W to the thickness T is preferably in a range from 0.33 to 2.83 both inclusive, in particular, although not particularly limited thereto. A reason for this is that in such a case, an internal volumetric capacity of the negative electrode container 20, that is, an available volume of an inside of the negative electrode container 20 for placement of the negative electrode 40 therein is ensured, which allows for suppression of the leakage of the alkaline electrolytic solution while allowing for a high battery capacity.

Note that respective values of the thickness T, the width W, and the ratio W/T are rounded off to two decimal places.

Note that the alkaline battery may further include any one or more of other components that are unillustrated.

Specifically, the alkaline battery may include a protective layer provided on an inner surface of the negative electrode container 20. The protective layer covers the inner surface of the negative electrode container 20 in a region where the negative electrode 40 and the negative electrode container 20 would be in contact with each other if it were not for the protective layer. The protective layer adjoins the negative electrode 40. Note that a range of provision of the protective layer may be expanded.

Specifically, the protective layer includes any one or more of metal materials that each have a hydrogen overvoltage higher than a hydrogen overvoltage of the material that the negative electrode container 20 includes. Thus, the negative electrode container 20 and the negative electrode 40 are electrically coupled to each other via the protective layer having an electrically conducting property. A reason for employing such a configuration is that this suppresses generation of a hydrogen gas caused by a partial battery reaction between the negative electrode active material included in the negative electrode 40, that is, the zinc-based material, and the negative electrode container 20.

For example, when the negative electrode container 20 includes the three-layer cladding material (nickel layer/stainless steel layer/copper layer) as described above, the protective layer includes any one or more of tin, indium, bismuth, gallium, or any other metal material that has a hydrogen overvoltage higher than a hydrogen overvoltage of the copper layer which is an outermost layer of the inner side of the negative electrode container 20.

The alkaline battery is manufactured by an example procedure described below. In this case, the positive electrode 30 and the negative electrode 40 are each fabricated, following which the alkaline battery is assembled using the positive electrode 30, the negative electrode 40, and other components.

The positive electrode active material and the positive electrode binder are mixed with each other, following which the mixture, i.e., a positive electrode mixture, is molded into a coin shape by means of a press molding machine. The positive electrode 30 is thus fabricated.

The one or more alkali metal hydroxides are put into the aqueous solvent to thereby prepare the alkaline electrolytic solution. Respective details of the aqueous solvent and the alkali metal hydroxides are as described above. Thereafter, the negative electrode active material, the alkaline electrolytic solution, and the thickener are mixed with each other. In this case, the mixture, i.e., a negative electrode mixture, may be heated on an as-needed basis. The negative electrode 40 is thus fabricated.

First, the positive electrode 30 is placed into the positive electrode container 10, following which the alkaline electrolytic solution is supplied into the positive electrode container 10. The positive electrode 30 is thereby impregnated with the alkaline electrolytic solution.

Thereafter, the separator 50 is disposed on the positive electrode 30 inside the positive electrode container 10, following which the alkaline electrolytic solution is supplied onto the separator 50. The separator 50 is thereby impregnated with the alkaline electrolytic solution. Thereafter, the gasket 60 is disposed on the separator 50 inside the positive electrode container 10. Thereafter, the negative electrode ring 70 is disposed on the separator 50, following which the negative electrode 40 is supplied to the inside of the opening 70K. In this case, furthermore, an additional amount of the alkaline electrolytic solution may be supplied onto the negative electrode 40. Thereafter, the negative electrode container 20 is disposed on the gasket 60 to thereby place the negative electrode container 20 partly inside the positive electrode container 10.

Lastly, the positive electrode container 10 and the negative electrode container 20 are crimped to each other with the gasket 60 interposed therebetween. This allows the positive electrode container 10 and the negative electrode container 20 to be fixed to each other with the gasket 60 interposed therebetween, and seals the components including, without limitation, the positive electrode 30, the negative electrode 40, the gasket 60, and the negative electrode ring 70 in the positive electrode container 10 and the negative electrode container 20. The alkaline battery is thus completed.

According to the alkaline battery, the positive electrode container 10 in which the positive electrode 30 is contained and the negative electrode container 20 in which the negative electrode 40 and the negative electrode ring 70 are contained are crimped to each other with the gasket 60 interposed therebetween. The gasket 60 is separated from the negative electrode ring 70. The separator 50 is disposed between the positive electrode 30 and the negative electrode 40. Further, the negative electrode 40 includes the negative electrode active material and the alkaline electrolytic solution. The negative electrode ring 70 surrounds the negative electrode 40 and adjoins the separator 50. Accordingly, for a reason described below, it is possible to achieve a superior liquid leakage resistance characteristic.

FIG. 3 illustrates a sectional configuration of an alkaline battery of a comparative example, and corresponds to FIG. 1. The alkaline battery of the comparative example has a configuration similar to the configuration of the alkaline battery according to the present embodiment (FIG. 1) except that no negative electrode ring 70 is provided and therefore the range of provision of the negative electrode 40 is expanded.

In the alkaline battery of the comparative example, as illustrated in FIG. 3, the range of provision of the negative electrode 40 is expanded. This allows the positive electrode 30 and the negative electrode 40 to be opposed to each other over a larger area, and accordingly allows for a higher battery capacity.

However, because of no barrier present between the negative electrode 40 and the gasket 60, it is easier for the alkaline electrolytic solution included in the negative electrode 40 to move along the liquid leakage path R. The alkaline electrolytic solution thus easily leaks to the outside of the positive electrode container 10 and the negative electrode container 20 through the gasket 60, which makes it difficult to achieve a superior liquid leakage resistance characteristic.

In contrast, in the alkaline battery according to the present embodiment, as illustrated in FIG. 1, the barrier, i.e., the negative electrode ring 70, is present between the negative electrode 40 and the gasket 60. In this case, the negative electrode ring 70 allows for an increase in the path length of the liquid leakage path R, thus helping to prevent the alkaline electrolytic solution included in the negative electrode 40 from easily moving along the liquid leakage path R. Moreover, making the width W of the negative electrode ring 70 sufficiently small helps to minimize a decrease in the battery capacity resulting from the reduced range of provision of the negative electrode 40. This helps to prevent the alkaline electrolytic solution from leaking to the outside of the positive electrode container 10 and the negative electrode container 20 through the gasket 60. Accordingly, it is possible to achieve a superior liquid leakage resistance characteristic.

In particular, the negative electrode ring 70 may adjoin the negative electrode container 20. This allows for a further increase in the path length of the liquid leakage path R. Accordingly, the leakage of the alkaline electrolytic solution is further suppressed. It is thus possible to achieve higher effects.

In addition, the negative electrode ring 70 may have the insulating property. This helps to prevent an unintentional short circuit from being caused by the presence of the negative electrode ring 70. Accordingly, the leakage of the alkaline electrolytic solution is suppressed while the occurrence of the short circuit is prevented. It is thus possible to achieve higher effects.

In this case, the negative electrode ring 70 may include the insulating polymer compound. This suppresses corrosion of the negative electrode ring 70 by the alkaline electrolytic solution, and accordingly suppresses the leakage of the alkaline electrolytic solution stably. It is thus possible to achieve higher effects. In addition, the insulating polymer compound may include polyolefin, polyamide, or both. This helps to prevent the negative electrode ring 70 from hydrolyzing easily, and accordingly allows for more stable suppression of the leakage of the alkaline electrolytic solution. It is thus possible to achieve further higher effects.

Further, the positive electrode container 10 and the negative electrode container 20 may be disposed to allow the openings 10K and 20K to face each other, the negative electrode container 20 may be partly placed inside the positive electrode container 10, and the sidewall parts 10Y and 20Y may be crimped to each other with the gasket 60 interposed therebetween. This fixes the positive electrode container 10 and the negative electrode container 20 to each other firmly and stably, with the gasket 60 interposed therebetween. Accordingly, the positive electrode container 10 and the negative electrode container 20 achieve an improved sealing characteristic, allowing for further suppression of the leakage of the alkaline electrolytic solution. It is thus possible to achieve higher effects.

In this case, the ratio W/T for the negative electrode ring 70 may be in the range from 0.33 to 2.83 both inclusive. This suppresses the leakage of the alkaline electrolytic solution while allowing for a high battery capacity. Accordingly, it is possible to achieve further higher effects.

The configuration of the alkaline battery is appropriately modifiable, for example, as described below. Note that any two or more of the following series of modifications described below may be combined with each other.

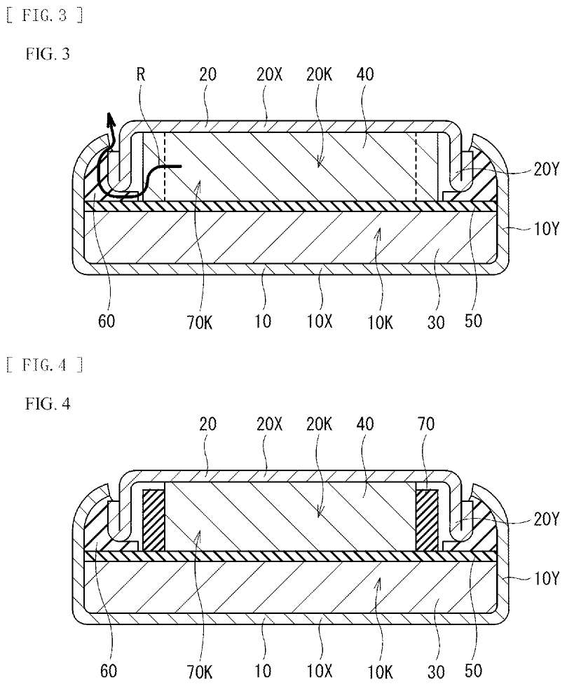

In FIG. 1, the negative electrode ring 70 adjoins the negative electrode container 20. However, as illustrated in FIG. 4 corresponding to FIG. 1, the negative electrode ring 70 does not necessarily have to adjoin the negative electrode container 20. More specifically, the negative electrode ring 70 may be separated from the negative electrode container 20, and therefore the negative electrode ring 70 and the negative electrode container 20 may have a gap therebetween.

Even in such a case, an increased path length of the liquid leakage path R is achievable by using the negative electrode ring 70. Accordingly, it is possible to achieve a superior liquid leakage resistance characteristic.

However, to achieve a further increased path length of the liquid leakage path R to thereby achieve a further improved liquid leakage resistance characteristic, the negative electrode ring 70 preferably adjoins the negative electrode container 20, as illustrated in FIG. 1. Note that when the negative electrode ring 70 does not adjoin the negative electrode container 20, it is preferable that the gap between the negative electrode ring 70 and the negative electrode container 20 be sufficiently small to make the liquid leakage path R sufficiently large in path length.

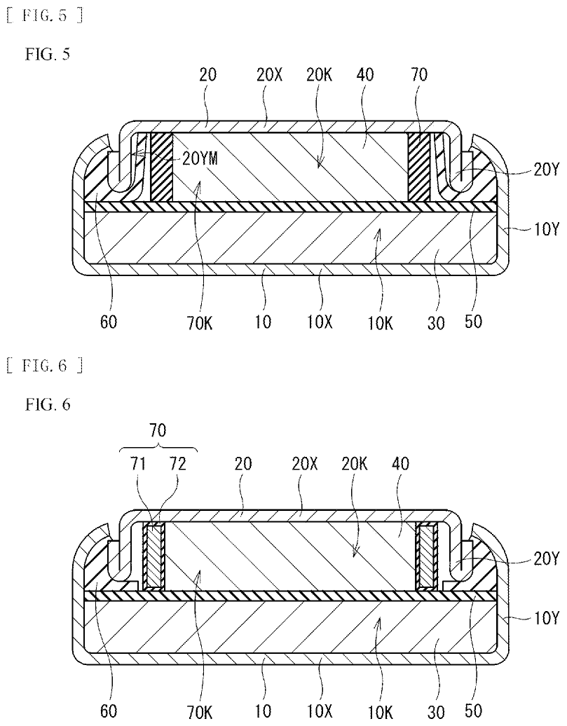

In FIG. 1, the gasket 60 terminates without being extended along the inner wall surface 20YM. However, as illustrated in FIG. 5 corresponding to FIG. 1, the gasket 60 may be extended along the inner wall surface 20YM.

Note that the gasket 60 may be extended along only a portion of the inner wall surface 20YM or along the entire inner wall surface 20YM. Thus, an end of the gasket 60 may be in contact with the negative electrode container 20 (the bottom part 20X) or in non-contact with the negative electrode container 20. FIG. 5 illustrates a case where the gasket 60 is extended along the entire inner wall surface 20YM and the end of the gasket 60 is thus in contact with the negative electrode container 20.

In this case, the gasket 60 may be in contact with the inner wall surface 20YM and thus cover the inner wall surface 20YM. Alternatively, the gasket 60 may be in non-contact with the inner wall surface 20YM and thus the inner wall surface 20YM and the gasket 60 may have a gap therebetween. FIG. 5 illustrates a case where the gasket 60 is in non-contact with the inner wall surface 20YM.

Even in such a case, an increased path length of the liquid leakage path R is achievable by using the negative electrode ring 70. Accordingly, it is possible to achieve a superior liquid leakage resistance characteristic.

In this case, the sealing characteristic of the positive electrode container 10 and the negative electrode container 20 improves, in particular. Further, if the end of the gasket 60 is in contact with the negative electrode container 20, the liquid leakage path R markedly increases in path length. This allows for a further improved liquid leakage resistance characteristic, making it possible to achieve higher effects.

Note that if the inner wall surface 20YM and the gasket 60 have a gap therebetween, a length margin is obtainable in relation to alignment between the positive electrode container 10 and the negative electrode container 20 when placing the negative electrode container 20 partly inside the positive electrode container 10 in the process of manufacturing the alkaline battery. As a result, it becomes easier to place the negative electrode container 20 partly inside the positive electrode container 10 even if the positive electrode container 10 and the negative electrode container 20 become somewhat misaligned with each other. This allows for easy and stable manufacture of the alkaline battery, thus providing an advantage also in terms of improved efficiency of manufacture of the alkaline battery.

In FIG. 1, the negative electrode ring 70 has a non-composite structure including the insulating polymer compound. However, as illustrated in FIG. 6 corresponding to FIG. 1, the negative electrode ring 70 may have a composite structure including a ring part 71 and a surface part 72.

The ring part 71 is a body part having a frame shape and constituting a skeletal structure of the negative electrode ring 70. The ring part 71 includes any one or more of metal materials including, without limitation, stainless steel. Details of the stainless steel are as described above. The ring part 71 has rigidity owing to including the one or more metal materials, and therefore serves as the skeletal structure for ensuring physical strength of the negative electrode ring 70.

The surface part 72 is a covering part covering a surface of the ring part 71, and includes a material similar to the material that the negative electrode ring 70 illustrated in FIG. 1 includes. More specifically, the surface part 72 includes any one or more of the insulating polymer compounds including, without limitation, polyolefin, polyamide, and polycarbonate. The surface part 72 is not particularly limited in thickness. The thickness of the surface part 72 may thus be chosen as desired.

In this case also, an increased path length of the liquid leakage path R is achievable by using the negative electrode ring 70. Accordingly, it is possible to achieve a superior liquid leakage resistance characteristic.

In this case, in particular, the negative electrode ring 70 improves in rigidity, which allows for an improved sealing characteristic of the positive electrode container 10 and the negative electrode container 20. As a result, the liquid leakage resistance characteristic improves further, making it possible to achieve higher effects.

### EXAMPLES

Examples of the present technology will be described according to an embodiment.

### Examples 1 to 10 and Comparative Example 1

Alkaline batteries were manufactured, and thereafter the alkaline batteries were evaluated for their respective characteristics.

### [Manufacturing of Alkaline Battery]

The alkaline batteries illustrated in FIGS. 1 and 4 to 6 were manufactured in accordance with the following procedure.

### (Fabrication of Positive Electrode)

Sixty nine point five parts by mass of the positive electrode active material (silver oxide), 20.0 parts by mass of the positive electrode active material (manganese dioxide), 10.0 parts by mass of the silver-nickel composite oxide (nickelite), and 0.5 parts by mass of the positive electrode binder (polytetrafluoroethylene) were mixed with each other to thereby obtain a positive electrode mixture. Thereafter, the positive electrode mixture was molded into a coin shape by means of a press molding machine. In this manner, the positive electrode 30 was fabricated.

### (Fabrication of Negative Electrode)

The alkali metal hydroxide (potassium hydroxide) was put into the aqueous solvent (pure water), following which the aqueous solvent was stirred to thereby prepare the alkaline electrolytic solution (an aqueous solution of potassium hydroxide having a concentration of 25%). Thereafter, 60 parts by mass of the negative electrode active material (a mercury-free zinc-based material, more specifically, a zinc-aluminum-bismuth-indium alloy), 38 parts by mass of the alkaline electrolytic solution, and 2 parts by mass of the thickener (carboxymethyl cellulose) were mixed with each other. In this manner, the negative electrode 40 was fabricated.

### (Assembly of Alkaline Battery)

First, the positive electrode 30 was placed into the positive electrode container 10 (SUS430), following which the alkaline electrolytic solution (the aqueous solution of potassium hydroxide described above) was dropped into the positive electrode container 10 to thereby impregnate the positive electrode 30 with the alkaline electrolytic solution.

Thereafter, the separator 50 was disposed on the positive electrode 30 inside the positive electrode container 10, following which the alkaline electrolytic solution (the aqueous solution of potassium hydroxide described above) was dropped onto the separator 50 to thereby impregnate the separator 50 with the alkaline electrolytic solution. As the separator 50, a multilayer film was used in which a nonwoven fabric, cellophane, and a microporous film graft-polymerized with polyethylene were stacked in this order.

Thereafter, the gasket 60 (a nylon film) having a ring shape was disposed on the separator 50 inside the positive electrode container 10. Thereafter, the negative electrode ring 70 (a non-composite type 1 or 2 or a composite type) was disposed on the separator 50, following which the negative electrode 40 was supplied to the inside of the opening 70K.

The negative electrode ring 70 of the non-composite type 1 included the insulating polymer compound (nylon 66, i.e., polyamide). The negative electrode ring 70 of the non-composite type 2 included the insulating polymer compound (polypropylene, i.e., polyolefin). In the negative electrode ring 70 of the composite type, the ring part 71 included the metal material (SUS430) and the surface part 72 included the insulating polymer compound (nylon 66, i.e., polyamide). The structure of the negative electrode ring 70, i.e., whether the negative electrode ring 70 was of the non-composite type 1, was of the composite type 2, or was of the composite type, is listed in the “Structure” column in Table 1.

The thickness T (mm), the width W (mm), and the ratio W/T of the negative electrode ring 70 were as listed in Table 1.

In a case of using the negative electrode ring 70, the thickness T was changed to thereby adjust whether to cause the negative electrode ring 70 to adjoin the negative electrode container 20. The “Adjoining to negative electrode container” column in Table 1 indicates whether the negative electrode ring 70 adjoined the negative electrode container 20.

Thereafter, the negative electrode container 20 (SUS304) was disposed on the gasket 60 to thereby place the negative electrode container 20 partly inside the positive electrode container 10.

Lastly, the positive electrode container 10 and the negative electrode container 20 were crimped to each other with the gasket 60 interposed therebetween. In this case, a width of the gasket 60 was changed to thereby adjust the presence or absence of extension of the gasket 60. The “Presence or absence of extension” column in Table 1 indicates whether the gasket 60 was extended. “Absent” under the “Presence or absence of extension” column indicates that the gasket 60 terminated without being extended along the inner wall surface 20YM (FIG. 1). In contrast, “Present” under the “Presence or absence of extension” column indicates that the gasket 60 was extended along the inner wall surface 20YM (FIG. 5).

In this manner, the positive electrode container 10 and the negative electrode container 20 were fixed to each other with the gasket 60 interposed therebetween. The alkaline battery (9.5 mm in outer diameter D and 1.4 mm in height H) was thus completed (Examples 1 to 10).

For comparison, the alkaline battery illustrated in FIG. 3 (Comparative example 1) was manufactured by a similar procedure except that no negative electrode ring 70 was used.

### [Characteristic Evaluation of Alkaline Battery]

Evaluation of the alkaline batteries for their liquid leakage resistance characteristics revealed the results presented in Table 1.

To evaluate the liquid leakage resistance characteristic, a storage test was performed on the alkaline battery in a high-temperature and high-humidity environment (at a temperature of 45° C. and a humidity of 93% RH) to thereby measure the number of days to an occurrence of leakage of the alkaline electrolytic solution, which was an index for evaluating the liquid leakage resistance characteristic. The number of days to the occurrence of liquid leakage was the number of days it took until a liquid leakage of level Cl occurred. A measurement procedure of the number of days to the occurrence of liquid leakage was in accordance with IEC 60086-3, a standard for primary batteries specified by the International Electrotechnical Commission (IEC).

Here, the alkaline batteries were evaluated also for their capacity characteristics, in addition to the above-described liquid leakage resistance characteristics. In this case, instead of measuring the battery capacity of the alkaline battery, the internal volumetric capacity (mm 3) of the negative electrode container 20 having an influence on the battery capacity was calculated. As described above, this internal volumetric capacity is the available volume of the inside of the negative electrode container 20 for placement of the negative electrode 40 therein. The battery capacity therefore increases with increasing internal volumetric capacity.

Note that values of the internal volumetric capacity listed in Table 1 are normalized values that were each obtained with respect to the value of the internal volumetric capacity in a case without the negative electrode ring 70 (Comparative example 1) assumed as 100.0. The normalized values of the internal volumetric capacity were rounded off to one decimal place.

TABLE 1

| | Negative electrode ring | | | | | | | |
|---|---|---|---|---|---|---|---|---|
| | | Adjoining | | | | Gasket | Number of | Internal |
| | | to negative | | | | Presence or | days to | volumetric |
| | | electrode | Thickness | Width W | Ratio | absence of | occurrence of | capacity |
| | Structure | container | T (mm) | (mm) | W/T | extension | liquid leakage | (normalized) |
| Example 1 | Non- | Yes | 0.60 | 0.15 | 0.25 | Absent | 35 | 87.8 |
| Example 2 | composite | Yes | 0.60 | 0.20 | 0.33 | Absent | 40 | 85.5 |
| Example 3 | type 1 | Yes | 0.60 | 0.60 | 1.00 | Absent | 60 | 68.2 |
| Example 4 | | Yes | 0.60 | 1.70 | 2.83 | Absent | 100 | 30.8 |
| Example 5 | | Yes | 0.60 | 1.75 | 2.92 | Absent | 120 | 29.4 |
| Example 6 | | No | 0.50 | 0.60 | 1.20 | Absent | 30 | 68.2 |
| Example 7 | | Yes | 0.60 | 0.60 | 1.00 | Present | 80 | 56.6 |
| Example 8 | Non- | Yes | 0.60 | 0.60 | 1.00 | Absent | 60 | 68.2 |
| | composite | | | | | | | |
| | type 2 | | | | | | | |
| Example 9 | Composite | Yes | 0.60 | 0.60 | 1.00 | Absent | 80 | 68.2 |
| Example 10 | type | Yes | 0.60 | 0.60 | 1.00 | Present | 100 | 56.6 |
| Comparative | — | — | — | — | — | Absent | 20 | 100.0 |
| example 1 | | | | | | | | |

As indicated in Table 1, the liquid leakage resistance characteristic of the alkaline battery having the negative electrode 40 including the alkaline electrolytic solution varied depending on the configuration of the alkaline battery.

Specifically, when no negative electrode ring 70 was used (Comparative example 1), the number of days to the occurrence of liquid leakage was small, which indicates that the leakage of the alkaline electrolytic solution occurred easily. In contrast, when the negative electrode ring 70 was used (Examples 1 to 10), the number of days to the occurrence of liquid leakage was large, which indicates that the leakage of the alkaline electrolytic solution did not occur easily.

In particular, when the negative electrode ring 70 was used, a series of tendencies described below was observed.

Firstly, when the negative electrode ring 70 adjoined the negative electrode container 20 (Example 3), the number of days to the occurrence of liquid leakage was larger than when the negative electrode ring 70 did not adjoin the negative electrode container 20 (Example 6).

Secondly, when the negative electrode ring 70 had a structure of the composite type (Example 9), the number of days to the occurrence of liquid leakage was larger than when the negative electrode ring 70 had a structure of the non-composite type 1 (Example 3) and when the negative electrode ring 70 had a structure of the non-composite type 2 (Example 8).

Thirdly, when the gasket 60 was extended along the inner wall surface 20YM (Example 7), the number of days to the occurrence of liquid leakage was larger than when the gasket 60 was not extended along the inner wall surface 20YM (Example 3).

Fourthly, when the ratio W/T was within an appropriate range, i.e., the range from 0.33 to 2.83 both inclusive (Examples 2 to 4), the internal volumetric capacity within an allowable range was obtained and the number of days to the occurrence of liquid leakage was sufficiently large, as compared with when the ratio W/T was outside the appropriate range (Examples 1 and 5).

The results presented in Table 1 indicate that when: the positive electrode container 10 and the negative electrode container 20 were crimped to each other with the gasket 60 interposed therebetween; the separator 50 was disposed between the positive electrode 30 and the negative electrode 40 (including the negative electrode active material and the alkaline electrolytic solution); and the negative electrode ring 70 surrounded the negative electrode 40 and adjoined the separator 50, the number of days to the occurrence of liquid leakage increased to suppress the leakage of the alkaline electrolytic solution included in the negative electrode 40. Accordingly, the alkaline battery achieved a superior liquid leakage resistance characteristic.

Although the present technology has been described herein including with reference to one or more embodiments including Examples, the configuration of the present technology is not limited thereto, and is therefore modifiable in a variety of ways.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An alkaline battery comprising:
a positive electrode containing member;
a negative electrode containing member;
a positive electrode contained inside the positive electrode containing member;
a negative electrode and a frame-shaped member contained inside the negative electrode containing member;
a separator disposed between the positive electrode and the negative electrode; and
a sealing member disposed between the positive electrode containing member and the negative electrode containing member and separated from the frame-shaped member, wherein
the positive electrode containing member and the negative electrode containing member are crimped to each other with the sealing member interposed between the positive electrode containing member and the negative electrode containing member,
the negative electrode includes a negative electrode active material and an alkaline electrolytic solution, and
the frame-shaped member surrounds the negative electrode and adjoins the separator.

2. The alkaline battery according to claim 1, wherein the frame-shaped member further adjoins the negative electrode containing member.

3. The alkaline battery according to claim 1, wherein the frame-shaped member has an insulating property.

4. The alkaline battery according to claim 3, wherein the frame-shaped member includes a polymer compound having an insulating property.

5. The alkaline battery according to claim 4, wherein the polymer compound includes polyolefin, polyamide, or both.

6. The alkaline battery according to claim 1, wherein the frame-shaped member includes
a body part including a metal material, and
a covering part having an insulating property and covering a surface of the body part.

7. The alkaline battery according to claim 1, wherein
the positive electrode containing member has a bowl shape, includes a first bottom part and a first sidewall part coupled to each other, and has a first opening,
the negative electrode containing member has a bowl shape, includes a second bottom part and a second sidewall part coupled to each other, and has a second opening,
the positive electrode containing member and the negative electrode containing member are disposed to allow the first opening and the second opening to face each other,
the negative electrode containing member is partly placed inside the positive electrode container, and
the first sidewall part and the second sidewall part are crimped to each other with the sealing member interposed between the first sidewall part and the second sidewall part.

8. The alkaline battery according to claim 7, wherein the sealing member is extended along at least a portion of an inner surface of the second sidewall part.

9. The alkaline battery according to claim 7, wherein a ratio of a width to a thickness is greater than or equal to 0.33 and less than or equal to 2.83, where the thickness is a dimension of the frame-shaped member in a direction in which the separator and the second bottom part are opposed to each other, and the width is a dimension of the frame-shaped member in a direction in which the negative electrode and the second sidewall part are opposed to each other.
